(19) United States
(12) Patent Application Publication
(10) Pub. No.: US 2007/0180779 A1
(43) Pub. Date: Aug. 9, 2007

(54) Saw blade for diamond tool

(76) Inventor: Fang-Chun Yu, Ying Ko Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/348,264

(22) Filed: Feb. 7, 2006

(51) Int. Cl. C09K 3/14; B24D 3/02; C09C 1/68

(52) U.S. Cl. 51/307; 51/309

(57) ABSTRACT

The present invention relates to a saw blade for diamond milling. More particularly, the surface of the cylinder metal or the shaped metal can be opened with multiple parallel spaces, or with cross mode. Also, the surface of the cylinder metal or the shaped metal can have the embedded groove with circular, vertical, or spiral shape for positioning diamond grains. As well, the metal surface is extruded by the formed jig, and the embedded groove is deformed and extrudes inwardly for embedding the diamond grains. Further, the surface can be electroplated with a metal electroplated layer, an electroplated layer with diamond grains, a metal layer by sintering, or a metal layer with diamond grains. The metal electroplated layer and the metal layer by sintering can increase the firmness for diamond grains. Moreover, the electroplated layer with diamond grains, or the metal layer with diamond grains can increase the life cycle and milling performance.

### BACKGROUND OF THE INVENTION

1. Field of the Invention

The present invention generally relates to a saw blade with improvement for diamond milling. More particularly, it is a structural improvement for the saw blade of diamond grinding.

2. Description of the Prior Art

The inventors keep doing research and improvement for improving the sharpness and strength of the diamond saw blade, and have proposed several structures of the diamond saw blades. For example, the inventors applied a patent of America Ser. No. 10/686,606 U.S. Pat. No. 6,932,076 “Diamond Circular Saw Blade”, and are going to file another patent application, “The Saw Blade For Diamond Tool” as shown in the present invention. The mentioned applications all improve the diamond saw blade, and the structures of the applications have been tested in practice. Moreover, the results of the tests all can achieve the expected performance with obviousness. In order to make the structures be widely used and have further improvement, the inventors again proposed another improved structure of the diamond saw blade based on the mentioned application. Further, the structure of the diamond saw blade in the present application was also tested and improved. Finally, a simple structure is proposed. The present invention can achieve a good milling performance as well as increase the life cycle for the usage.

The examiner can refer to the following drawings and descriptions, and completely understand the structure, purpose, method and spirit of the present invention.

### SUMMARY OF THE INVENTION

The present invention relates to a saw blade with improvement for diamond milling. Please refer to FIG. 1, the surface of the cylinder metal 10 has the circular embedded groove 101 with spacing arrangement, or the vertical embedded groove 101a as shown in FIG. 1A, or (FIG. 2) the spiral embedded groove 102 (please refer to FIG. 3 to FIG. 6). Further, the surface of the shaped metal 20 has the embedded groove 102a. The embedded groove 102a can be opened with multiple spaces (FIG. 3 to FIG. 4), or with cross mode (FIG. 5 and FIG. 6). As well, the embedded groove 102a (refer to FIG. 3 and FIG. 6) can be opened with bevel (refer to FIG. 3, and FIG. 6). Further, the embedded grooves 101, 101a, 102, and 102a are the openings for positioning diamond grains 2.

### BRIEF DESCRIPTION OF THE DRAWINGS

FIG. 1 is a 3-D graph showing a cylinder metal with the embedded groove in the present invention;

FIG. 1A is one 3-D preferred embodiment showing a cylinder metal with the embedded groove in the present invention;

FIG. 2 is another 3-D preferred embodiment showing a cylinder metal with the embedded groove in the present invention;

FIG. 3 is a 3-D graph showing a shaped metal with the embedded groove in the present invention;

FIG. 4 is one 3-D preferred embodiment showing a shaped metal with the embedded groove in the present invention;

FIG. 5 is another preferred embodiment showing a shaped metal with the embedded groove in the present invention;

FIG. 6 is one of the preferred embodiments showing a shaped metal with the embedded groove in the present invention;

FIG. 7 is a 3-D graph showing the embedded groove of the cylinder metal with diamond grains in the present invention;

FIG. 8 is a cross-sectional graph showing the embedded groove of the cylinder metal with diamond grains in the present invention;

FIG. 8A is one 3-D preferred embodiment showing the embedded groove of the cylinder-metal with diamond grains in the present invention;

FIG. 9 is another 3-D preferred embodiment showing the embedded groove of the cylinder metal with diamond grains in the present invention;

FIG. 10 is one of the preferred embodiments showing the embedded groove of the cylinder metal with diamond grains in the present invention;

FIG. 11 is a 3-D graph showing the embedded groove of the shaped metal with diamond grains in the present invention;

FIG. 12 is one 3-D preferred embodiment showing the embedded groove of the shaped metal with diamond grains in the present invention;

FIG. 13 is another 3-D preferred embodiment showing the embedded groove of the shaped metal with diamond grains in the present invention;

FIG. 14 is one of the preferred embodiments showing the embedded groove of the shaped metal with diamond grains in the present invention;

FIG. 15 is a cross-sectional graph showing the embedded groove of the cylinder metal with diamond grains which also is electroplated with a metal electroplated layer;

FIG. 16 is one cross-sectional preferred embodiment showing the embedded groove of the cylinder metal with diamond grains which is also electroplated with a metal electroplated layer;

FIG. 17 is a cross-sectional graph showing the embedded groove of the cylinder metal with diamond grains which is also electroplated with a diamond electroplated layer;

FIG. 18 is one cross-sectional preferred embodiment showing the embedded groove of the cylinder metal with diamond grains which is also electroplated with a diamond electroplated layer.

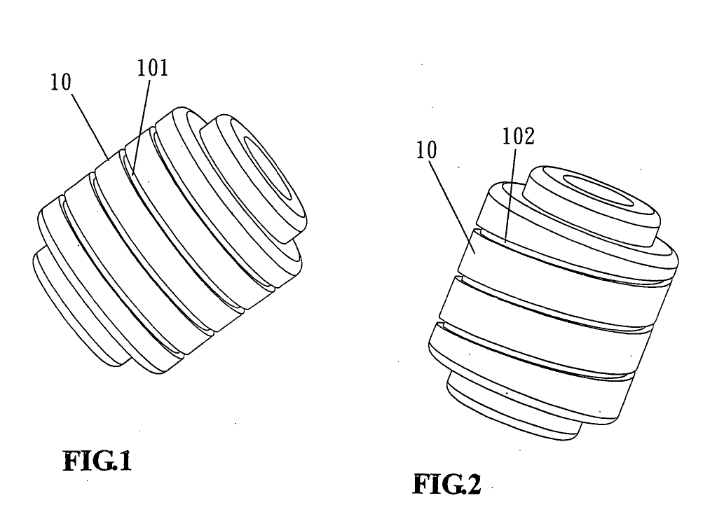

### DETAILED DESCRIPTION OF THE INVENTION

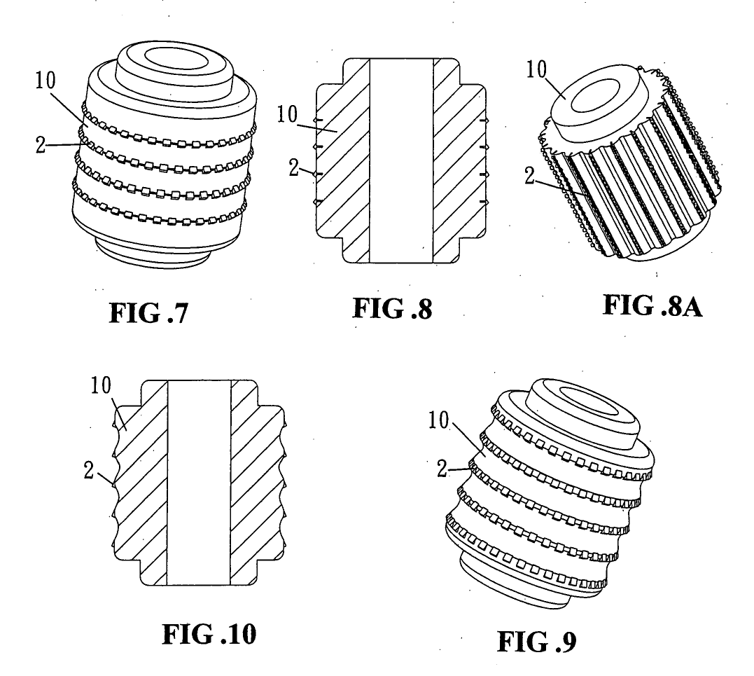

Please refer to FIGS. 7, 8, 8A, 9, and 10. The figures show the cylinder metal 10 having the embedded grooves 101, 101a, and 102 for positioning diamond grains 2. Moreover, the embedded grooves 101, 101a, and 102 under the pressure from the formed jig are deformed and inwardly extrude to embed the diamond grains firmly. While the formed jig is pressed on the embedded grooves 101, 101a, 102, the diamond grains 2 are embedded into the embedded grooves firmly because the embedded grooves are deformed. Under the pressure from the formed jig, the surface of the cylinder metal 10 (refer to FIG. 7) can be plane or rugged shape (refer to FIG. 9 and FIG. 8A). Further, the surface is changed from the line design of the formed jig while under the pressure.

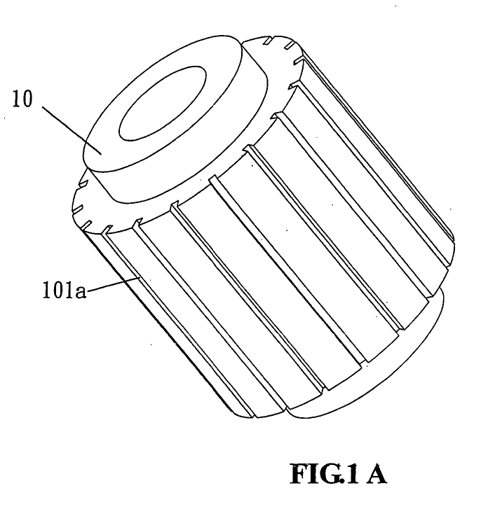

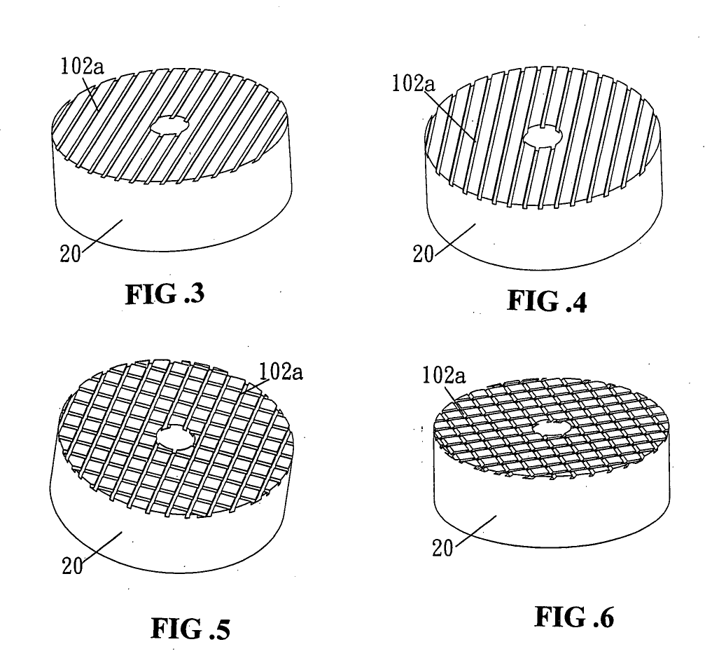

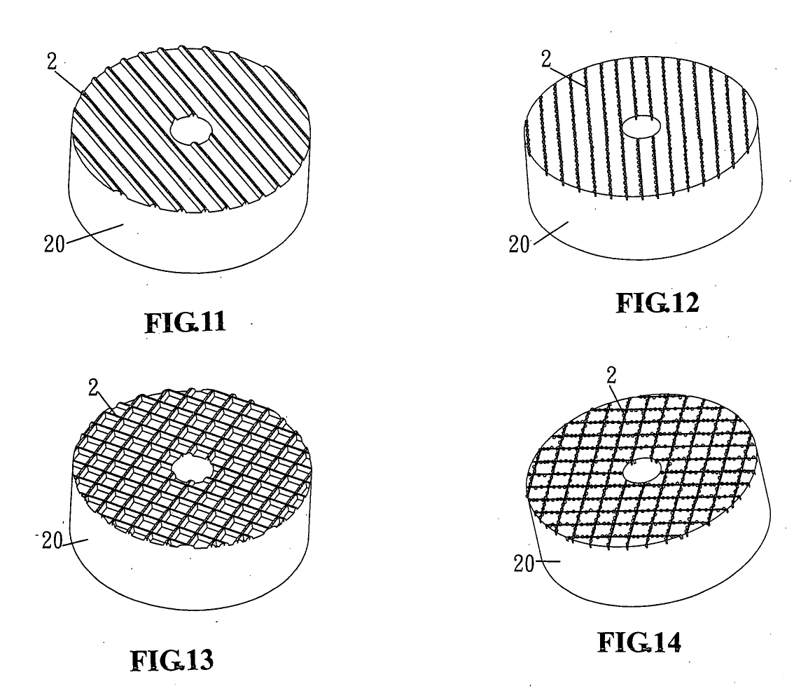

As shown in FIGS. 11, 12, 13, and 14, the embedded groove 102a of the shaped metal 20 with diamond grains 2 in the present invention (please refer to FIG. 3 to FIG. 6). Later, the embedded groove is extruded from the formed jig, and the embedded groove 102a is deformed and inwardly extrudes for embedding the diamond grains 2 firmly. In other words, the embedded groove 102a is deformed and embeds the diamond grains 2 firmly while under the pressure from the formed jig. After under the pressure from the formed jig, the surface of the shaped metal 20 (refer to FIG. 12 and FIG. 14) can be plane or rugged shape (refer to FIG. 11 and FIG. 13). Further, the surface is changed from the line design of the formed jig while under the pressure.

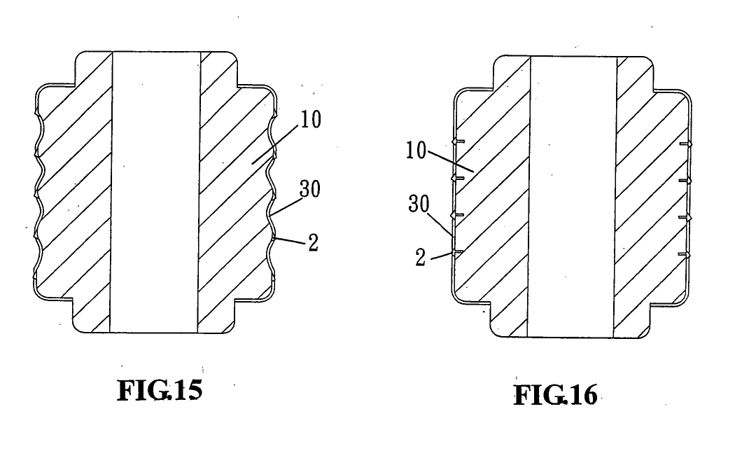

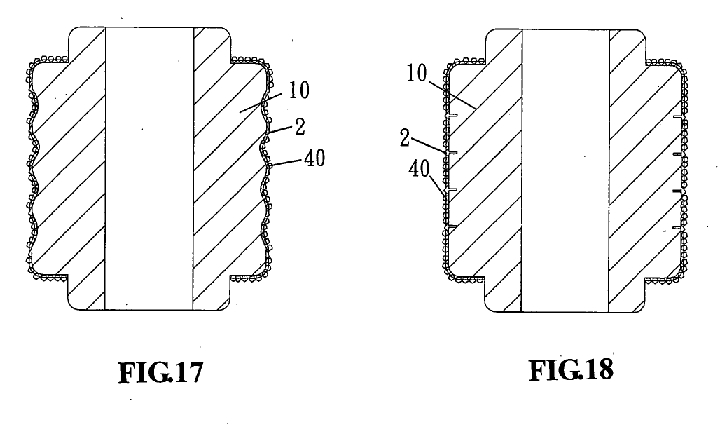

The diamond grains 2 are embedded into the cylinder metal 10 and the shaped metal 20 after under the extrusion from the formed jig (please refer to FIG. 7 to FIG. 14). Further, the surface can be electroplated with the metal electroplated layer 30 (refer to FIG. 15 and FIG. 16), the metal layer by sintering, the electroplated layer 40 with diamond grains (refer to FIG. 17 and FIG. 18), or the diamond layer by metal sintering. The metal electroplated layer 30 and the metal layer by sintering can increase the firmness for the diamond grains 2. As well, the electroplated layer with diamond grains 40 or the diamond grain layer by metal sintering can increase the lifecycle and the milling performance for the usage.

According to the above-mentioned descriptions, the present invention can increase the lifecycle and the sharpness of performance. The structure of the present invention is simple, and has not been published for the usage. Therefore, the present invention can meet the utility, and novelty of the patent requirements. The applicant has applied the patent lawfully in this instance. It is appreciated if the examiner can proceed with the examination promptly.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A diamond saw blade with improvement for milling mainly featuring:
the surface of the cylinder metal having a circular embedded groove with spacing arrangement, or a vertical embedded groove, or a spiral embedded groove; the surface of a shaped metal having a embedded groove; wherein said embedded groove possible opened with multiple spaces or with cross mode; wherein the embedded groove possible opened with bevel; wherein the embedded groove provided for positioning diamond grains;
wherein the embedded groove of the cylinder metal or the shaped metal with diamond grains while under the pressure from the formed jig deformed and inwardly extruding to embed the diamond grains firmly; wherein said surface possible electroplated with the metal electroplated layer, the metal layer by sintering, the electroplated layer with diamond grains, or the diamond layer by metal sintering.

2. The diamond saw blade of claim 1, wherein said metal electroplated layer and said metal layer by sintering can increase the firmness for the diamond grains.

3. The diamond saw blade of claim 1, wherein said electroplated layer with diamond grains or said metal sintering layer with diamond grains can increase the lifecycle and milling performance for the usage.

4. The diamond saw blade of claim 1, wherein the pressure from the formed jig can make the embedded groove deformed, and the diamond grains can be firmly embedded into the embedded groove; wherein the surface of the cylinder metal or the shaped metal can be a plane or rugged shape after under the pressure from the formed jig; wherein the surface is changed from the line design of the formed jig while under the pressure.
